(19) United States
(12) Patent Application Publication
(10) Pub. No.: US 2008/0090702 A1
(43) Pub. Date: Apr. 17, 2008

(54) Parking Brake System With Improved Control

(75) Inventors: Steffen Hopf, Regensburg (DE); Manfred Ringlstetter, Weng (DE)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: SIEMENS AKTIENGESELLSCHAFT, Munchen (DE)

(21) Appl. No.: 11/569,307

(22) PCT Filed: Feb. 28, 2005
(86) PCT No.: PCT/EP05/50831

§ 371 Date: Nov. 17, 2006

(30) Foreign Application Priority Data
May 18, 2004 (DE) 10 2004 024 654.8

(51) Int. Cl. B60T 7/10

(52) U.S. Cl. 477/197

(57) ABSTRACT

In an electronic parking brake system and a method for controlling said system, the parking brake system control (12) shifts to a second operational state (38) when the system is in a secure state (40) and the ignition is turned off. In the second state, consumption of quiescent current is reduced as a result of a drop in input interface (20) request frequency.

### CROSS-REFERENCE TO RELATED APPLICATIONS

This application is a U.S. national stage application of International Application No. PCT/EP2005/050831 filed Feb. 28, 2005, which designates the United States of America, and claims priority to German application number DE 10 2004 024 654.8 filed May 18, 2004, the contents of which are hereby incorporated by reference in their entirety.

### TECHNICAL FIELD

The invention relates to an electronic parking brake system with at least one control featuring an input interface, with signals being able to be recorded by the control via the input interface in a first operational state with a first frequency.

### BACKGROUND

In addition, the invention also refers to a method for controlling an electronic parking brake system with at least one control featuring an input interface, with the control recording signals with a first frequency in a first operational state via the input interface.

Electronic parking brake systems, also referred to as electronic parking brakes, are increasingly replacing purely mechanical handbrakes in motor vehicles. By using electronic parking brake systems, the relatively large control lever, which is fitted in the passenger compartment, is dispensed with, resulting in a considerably increased freedom of design of the passenger compartment. In addition, such a system provides greater convenience in operation, because on the one hand the operator does not have to exert such great forces in order to apply or release the brake and, on the other hand, different functions, such as for instance starting on a hill (hill hold) or the release of the brake on start-up for the first time after parking (drive away), can be carried out electronically and therefore also automatically. However, these advantageous features of an electronic parking brake system must be accompanied with a comparable or an improved security and an acceptable consumption of the quiescent current compared to a purely mechanical handbrake.

An electronic parking brake system must assume a secure operational state in each movement state of the motor vehicle. In general, in the case of a moving vehicle, this is “Parking brake released” and in the case of a stationary vehicle “Parking brake applied”. On the one hand, a shift between these two states can be carried out by means of automatic functions. In this case, the control, with due regard to a security concept, initiates the control commands for changing the current state of a system in accordance with the relevant general conditions. On the other hand, a change in the state as a result of a driver wish can also be signaled and implemented accordingly via a read-in instrument providing sufficient redundant operation.

A part of the above-mentioned security concept is that specific automatic functions such as for example the above-mentioned start on a hill (“hill hold”) or the automatic release of the brake when the vehicle moves off (“drive away”), is then only permitted when the vehicle's ignition is turned on. On the other hand, if the ignition is turned off, it is also possible to make provision for applying the parking brake automatically in accordance with specific general conditions.

Similarly, for safety-related reasons, it is also possible to limit the driver wishes, indicated by means of the input instrument so that, in the event of the ignition being turned off the only action permitted is an application of the parking brake. It is then only possible to release the parking brake after a renewed ignition cycle or by means of an automatic function under certain conditions.

To enable the control to be informed about a request made by the input instrument, said input instrument is polled at a specific frequency. This functionality must also have been implemented in systems of the prior art, even when the motor vehicle is in a stationary state, in particular, in those cases where the ignition is turned off. In order to be able to record a signal of the input instrument triggered by a wish of the driver of the motor vehicle, the current state of the input instrument is polled at regular intervals in the prior art. In general, when the ignition is turned off, and because the control is in an operational state in which, for reasons of reduced energy consumption, it cannot detect the corresponding signal of the input instrument, the control has to be put into an active operational state. In said operational state, it is then possible to detect the state of the input instrument and corresponding measures can be carried out accordingly. Such a cyclic request raises the quiescent current depending on the polling cycle.

### SUMMARY

There exists a need to overcome the disadvantages of the prior art and especially to make available a device and a method to bring about a reduction in the consumption of the quiescent current of a parking brake system.

A method for controlling an electronic parking brake system with at least one control having an input interface for detecting a desire of the driver, the method comprising the steps of: detecting in a first operational state of the control, signals via the input interface with a first frequency, detecting in a second operational state of the control, signals via the input interface with a second frequency wherein the second frequency is less than the first frequency, assuming the first operational state of the control as a result of the parking brake system being in a non-secure state with the ignition turned off, and assuming the second operational state of the control, as a result of the parking brake system being in a secure state with the ignition turned off.

In an embodiment, the second frequency may be 0. In an embodiment, the control may detect signals via the input interface which representing a desire of the driver. In an embodiment, the secure state of the parking brake system may be characterized by the property “parking brake applied”.

An electronic parking brake system may comprise at least one control having an input interface, with signals being able to be detected in a first operational state, by the control via the input interface with a first frequency, wherein the control is designed to detect in a second operational state signals via the input interface with a second frequency wherein the second frequency is lower than the first frequency, and wherein the control is further designed to assume the second operational state if the parking brake system is in a secure state with the ignition turned off.

In an embodiment, the control may be further designed to assume a first operational state if the parking brake system is in a non-secure state with the ignition turned off. In an embodiment, the second frequency may be 0. In an embodiment, the control may be designed to detect signals via the input interface which represent a wish of the driver. In an embodiment, the secure state of the parking brake system may be characterized by the property “parking brake applied”. In an embodiment, the control may comprise a microcontroller.

### BRIEF DESCRIPTION OF THE DRAWINGS

The invention will now be described with reference to the accompanying drawings on the basis of preferred exemplary embodiments. These drawings are as follows:

FIG. 1a a functional block diagram explaining a device in the first state of the inventive system;

FIG. 1b a functional block diagram explaining a device in the second state of the inventive system; and

FIG. 2 a flowchart explaining an inventive method.

### DETAILED DESCRIPTION

The inventive system builds on the generic system in that it is possible for the control in a second operational state to detect signals via the input interface with a second frequency and the second frequency is less than the first frequency and that the second operational state can be assumed if the parking brake system is in a secure state when the ignition is turned off. The frequency at which the input interface is tested for signals can thus be reduced if there is no need to translate a possible driver wish indicated by a signal at the input interface. This also simultaneously reduces the energy consumption of the control by comparison with the first operational state. The reduction in the frequency is undertaken if the parking brake system is already in a secure state with the ignition turned off and thus a change in the system state would put it into a non-secure state. Such a change of the state of the system and, thereby, also a change in the operational state of the control, is then only undertaken in the case of changing external conditions such as for example a renewed ignition cycle. This enables a relatively low-cost design to be used to effect a considerable reduction in the consumption of the potential energy of the parking brake system due to the fact that a secure state of the parking brake system is desirable in any event when the ignition is turned off and this state is generally assumed.

According to a further development of the invention, it is possible for embodiment to be designed in such a way that a first operational state can be assumed if the parking brake system is in a non-secure state when the ignition is turned off. This ensures that, even if the ignition is turned off, it is possible to implement a signal present at the input interface of the control, even if the motor vehicle is in a non-secure state. Hence it is still made possible to put the parking brake system into a secure state.

Likewise, in the case of a further development of the invention, provision can made for the second frequency to be 0. This further optimizes the consumption of the quiescent current of the parking brake system control because the control no longer shifts into the active state.

An embodiment provision can especially be made for signals representing a driver wish to be detected via the input interface. This makes it possible for the driver, in a first operational state of the control, to influence the state of the system, especially to put the system into a secure state, and thereby to also make possible a change of the operational state of the control from the first operational state to the second operational state.

In addition, it is possible for the inventive device to be arranged in such a way that the secure state of the parking brake system is characterized by the characteristic “parking brake applied”. This state prevents the motor vehicle moving by itself and can only be cleared by a renewed ignition cycle or by automatic functions taking into account a security concept in each case.

In addition, it is possible for the inventive device to be developed further in an advantageous manner by the inclusion of a microcontroller in the control. The use of a microcontroller can in particular be advantageous for detection of the signals arriving at the input interface of the control, because it guarantees a low consumption of quiescent current even in the first operational state.

The invention builds on the generic method in that the control detects signals via the input interface with a second frequency in a second operational state and that the second frequency is less than the first frequency and that the control assumes the second operational state if the parking brake system control is in a secure state with the ignition turned off. In this way, the advantages and the special features of the device according to the invention are also implemented within the framework of a method. This also applies to the following especially preferred embodiments of the inventive method described below.

The method is in particular developed further in an advantageous manner in that the control assumes a second operational state if the parking brake system is in a non-secure state with the ignition turned off.

A particularly useful further development of the inventive method consists of the second frequency being 0.

An advantageous embodiment of the method is especially produced by the control in each case detecting signals via the input interface which represent the wish of a driver.

In addition, the present invention further relates to a motor vehicle with an electronic parking brake system with an inventive device.

The present invention is based on the knowledge that, as soon as the electronic parking brake system and, thereby, also the motor vehicle as a whole, are in a secure state, it is possible to dispense with interrogating any possible driver wish and thus the consumption of the quiescent current of the electronic parking brake system can be reduced to a considerable extent. This is usually the case if the parking brake system is in the “parking brake applied” state and the ignition is turned off.

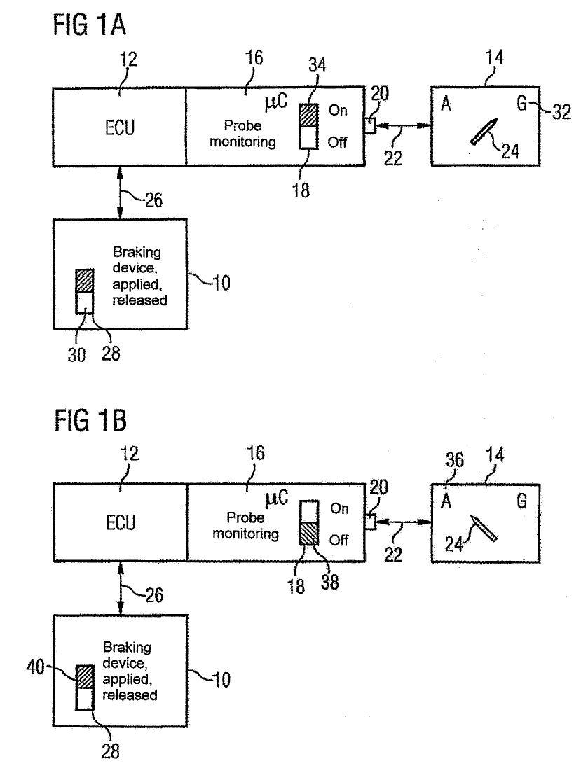

FIG. 1a shows a functional block diagram explaining a device according to the invention in a first state of the system. In addition to the electronic components, the mechanical components and possibly the hydraulic components known according to the prior art, and covered here by the term braking device 10, the embodiment shown features an electronic control unit (ECU) 12 and a probe 14. The electronic control unit 12 comprises units such as a microcontroller (μC) 16 with a symbolic probe monitoring indicator 18 and an input interface 20. The input interface 20 is connected via the signal line 22 to a probe 14 and the probe monitoring indicator 18 can assume the states ON and OFF. In addition, the probe 14 also has a control lever 24, which can be moved to the positions A for “Parking brake applied” and G for “Parking brake released”. In addition, the electronic control unit 12 is connected via the control line and the signal line 26 to the braking device 10. The braking device 10 also has a symbolic indicator 28, which can switch between the states of the braking device 10, “parking brake applied”, and “parking brake released”.

FIG. 1b shows a functional block diagram explaining an inventive device in a second state of the system. The embodiment shown in FIG. 1b is identical in its components to the electronic control unit shown in 1a, including the reference symbols, however, the microcontroller 16, the probe 14 and the braking device 10 are all in other states.

In both FIG. 1a and FIG. 1b, the ignition are turned off and this at least means that significant current-consuming devices are not supplied with current. The braking device 10 is in the released state 30, which is shown by means of an indicator 28. This state corresponds to the position of the control lever 24 of the probe 14, which is in the position G, 32, for released. Because the ignition is in the turned-off state, the probe 14 is monitored cyclically by the microcontroller 16, which is indicated by the probe monitoring indicator 18. This is correspondingly the case in state 34. For this purpose, the microcontroller 16 shifts at regular intervals from a low power mode to an active state, requests via the signal line the position of the control lever 24 of the probe 14 and in the case of an unchanged position of the probe 14, returns to the low power mode. Said process is carried out at regular intervals in time and consumes a certain amount of quiescent current.

In FIG. 1b, the driver of the motor vehicle has moved the control lever 24 to position A, 36. This was detected during the next subsequent monitoring cycle of the microcontroller 16 via a signal arriving at the input interface 20 along a signal line 22 from probe 14. It is accordingly changed to the mode “Probe monitoring OFF” 38. As a result, the microcontroller 16 has woken up the electronic control unit 12 as well as the whole system and subsequently forwards the signal to the electronic control unit 12. The electronic control unit 12, via the control line and the signal line 26 has triggered the braking device 10 to shift its operational state from “parking brake released” to “parking brake applied” 40, which is indicated by the change in the state indicator 28. Because the braking device 10 is now in a secure state 40, the microcontroller 16 ends the monitoring of the probe 14 and remains in the low power mode for the long-term now and is indicated by the probe monitoring indicator 18. Only a renewed ignition cycle or triggering of automatic functions authorized to do this is the microcontroller 16 again shifted to an active state.

As an alternative to the embodiment described in FIGS. 1a and 1b, an automatically functioning control unit could be provided instead of the probe 14 either as an alternative or in addition to it, to transfer the braking device 10 under specific general circumstances into the brake-applied, and thereby secure state.

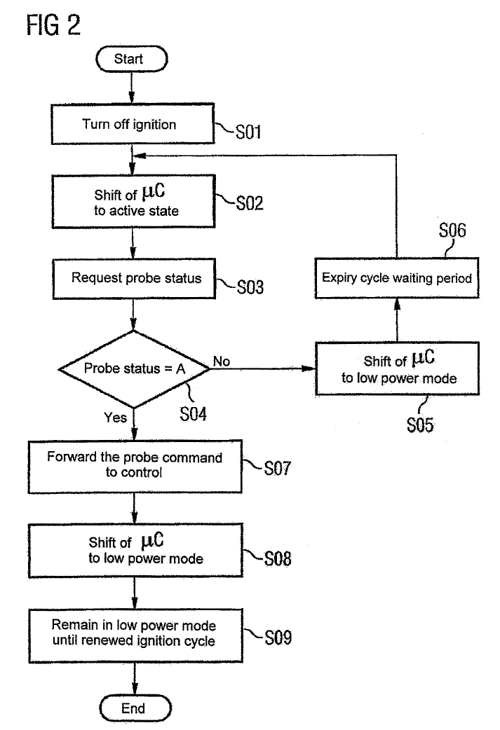

FIG. 2 shows a flowchart explaining an inventive method. The description of the inventive method starts at that point in time at which, for a motor vehicle employing the inventive method, the ignition is turned off, which is shown by step S01. At this point in time, the microcontroller 16 starts its monitoring cycle, which has been adapted to a low consumption of the quiescent current, which includes steps S02 to S06. In order to be able to check the status of the probe 14, the microcontroller 16 starts its cycle with a step S02 by shifting from the low power mode to an active state. In said active state, the microcontroller 16 requests the present status of probe 14 and checks whether or not the probe 14 has assumed the status A, such as “parking brake applied” (steps S03 to S04). If the probe 14 is still in status G and, thereby, the parking brake system is in a non-secure state, the checking cycle continues with step S05, in which the microcontroller 16 again shifts back to the low-power mode. With a step S06, a cycle waiting period elapses in which the microcontroller 16 is in its low power mode and the probe 14 is not being interrogated. After this cycle waiting period has elapsed, the checking cycle starts again at step S02, in which the microcontroller 16 again shifts to the active state. If in step S04, on checking the probe status it is established that the parking brake system is to shift to the applied state 40, the method continues with step S07. In this case, the probe command 22 is forwarded to the control 12, which implements said command and hence brings the parking brake system into the applied state 40 and thereby also into a secure state. Accordingly the microcontroller 16 can now return to the low power mode with step S08 and, as shown in step S09, remain in this low power mode 38 until a renewed ignition cycle occurs. Alternatively or in addition to an ignition cycle, it is also possible for automatic functions to be provided, which can be authorized to wake up the microcontroller under the appropriate general conditions.

Disclosed is an electronic parking brake system as well as a method for controlling said system in which the parking brake system control 12, provided the system is in a secure state 40 when the ignition is turned off, shifts to a second operational state 38 in which, because fewer requests are made at an input interface 20, the consumption of the quiescent state current is lower.

What is claimed is:

1. A method for controlling an electronic parking brake system with at least one control having an input interface for detecting a desire of the driver, the method comprising the steps of:
detecting in a first operational state of the control, signals via the input interface with a first frequency, and
the control, detecting in a second operational state of the control, signals via the input interface with a second frequency wherein the second frequency is less than the first frequency,
the first operational state of the control as a result of the parking brake system being in a non-secure state with the ignition turned off, and
the second operational state of the control, as a result of the parking brake system being in a secure state with the ignition turned off.

2. The method according to claim 1, wherein
the second frequency is 0.

3. The method according to claim 1, wherein
the control detects signals via the input interface which representing a desire of the driver.

4. The method according to claim 1, wherein
the secure state of the parking brake system is characterized by the property “parking brake applied”.

5. (canceled)

6. An electronic parking brake system comprising at least one control having an input interface, with signals being able to be detected in a first operational state, by the control via the input interface with a first frequency,
wherein the control is designed to detect in a second operational state signals via the input interface with a second frequency wherein the second frequency is lower than the first frequency, and
wherein the control is further designed to assume the second operational state if the parking brake system is in a secure state with the ignition turned off.

7. The electronic parking brake system according to claim 6, wherein
the control is further designed to assume a first operational state if the parking brake system is in a non-secure state with the ignition turned off.

8. The electronic parking brake system according to claim 6, wherein
the second frequency is 0.

9. The electronic parking brake system according to claim 6, wherein
the control is designed to detect signals via the input interface which represent a wish of the driver.

10. The electronic parking brake system according to claim 6, wherein
the secure state of the parking brake system is characterized by the property “parking brake applied”.

11. The electronic parking brake system according to claim 6, wherein
the control comprises a microcontroller.
